(19) United States
(12) Patent Application Publication
(10) Pub. No.: US 2012/0295621 A1
(43) Pub. Date: Nov. 22, 2012

(54) MOBILE COMMUNICATION METHOD AND EXCHANGE

(75) Inventors: Takashi Morita, Tokyo (JP); Itsuma Tanaka, Tokyo (JP); Kazuki Takita, Tokyo (JP)

(73) Assignee: NTT DOCOMO, INC., Tokyo (JP)

(21) Appl. No.: 13/518,020

(22) PCT Filed: Dec. 24, 2010
(86) PCT No.: PCT/JP2010/073433

§ 371 Date: Jul. 25, 2012

(30) Foreign Application Priority Data
Dec. 24, 2009 (JP) 2009-293017

(51) Int. Cl. H04W 36/00

(52) U.S. Cl. 455/436

(57) ABSTRACT

The present invention includes the steps of: receiving, from a mobile terminal (UE) having moved from a management area of an exchange (SGSN #1) to a management area of an exchange (SGSN #2), a location update request signal including a temporary subscriber identifier, at the exchange (SGSN #2); sending, from the exchange (SGSN #2) having received the location update request signal to the exchange (SGSN #1), a communication path information request signal for requesting to get communication path information stored in the exchange (SGSN #1), by using a protocol corresponding to the communication path type indicated by the temporary subscriber identifier; and sending, from the exchange (SGSN #1) having received the communication path information request signal to the exchange (SGSN #2), a communication path information response signal including the communication path information, by using the same protocol as that of the communication path information request signal.

### TECHNICAL FIELD

The present invention relates to a mobile communication method and an exchange that get bearer information related to a mobile terminal from other exchange when the mobile terminal moves from a management area of the other exchange to a management area of the exchange.

### BACKGROUND ART

The current 3GPP specification defines, when a terminal in idle mode moves between exchanges SGSN, processing of getting a bearer in a preservation state from a source exchange SGSN to a destination exchange SGSN (Non-Patent Literature 1). There are bearer types such as GPRS bearer and EPS bearer, and the current 3GPP specification describes that a PDP context indicating GPRS bearer information and an EPS context indicating EPS bearer information are only gotten by using GTPv1 (GPRS Tunneling Protocol, version 1) and GTPv2 (GPRS Tunneling Protocol, version 2) respectively (Non-Patent Literatures 2 and 3).

FIGS. 15 (A) and (B) show a procedure for getting the bearer information from an exchange SGSN#1 which is the moving source of a mobile terminal UE to an exchange SGSN#2 which is the moving target of the mobile terminal; FIG. 15 (A) showing a case where the bearer information is gotten by using GTPv1 and FIG. 15 (B) showing a case where the bearer information is gotten by using GTPv2.

As shown in FIG. 15 (A), when the mobile terminal in idle mode moves between exchanges SGSN and requests location update to the destination exchange SGSN#2, the destination exchange SGSN#2 gets the GPRS bearer information established on the source side with respect to the source exchange SGSN#1. For this reason, the destination exchange SGSN#2 requests the bearer information from the source exchange SGSN#1 by using GTPv1. The source exchange SGSN#1 sets, in a response signal, the bearer information of the currently established GPRS bearer upon receiving the request using GTPv1 from the destination exchange SGSN#2 and returns the response signal. The destination exchange SGSN#2 gets the bearer information based on the bearer information set in the response signal from the source exchange SGSN#1 and establishes a new GPRS bearer between the destination exchange SGSN#2 and a packet gateway GGSN using GTPv1 based on the bearer information.

Furthermore, as shown in FIG. 15(B), when the source exchange SGSN#1 gets an EPS bearer established with a packet gateway P-GW (not shown) via a serving gateway S-GW, the destination exchange SGSN#2 requests bearer information to the source exchange SGSN#1 by using GTPv2. Upon receiving the request from the destination exchange SGSN#2 by using GTPv2, the source exchange SGSN#1 sets the bearer information of the currently established EPS bearer in a response signal and returns the response signal. The destination exchange SGSN#2 gets the bearer information based on the bearer information set in the response signal and establishes a new EPS bearer between the destination exchange SGSN#1 and the serving gateway S-GW using GTPv2 based on the bearer information.

### CITATION LIST

### Non-Patent Literature

Non-Patent Literature 1: 3GPP TS23.060 (Version 8.7.0)
Non-Patent Literature 2: 3GPP TS29.060 (Version 8.10.0)
Non-Patent Literature 3: 3GPP TS29.274 (Version 8.4.0)

### SUMMARY OF INVENTION

### Technical Problem

In order to achieve interoperability between UMTS and EPS, the exchange SGSN that connects an LTE-capable mobile terminal to an EPC network supports both GTPv1 and GTPv2. For this reason, when the bearer information is gotten from the source exchange SGSN, the bearer information is requested using predetermined GTPv1 or GTPv2. However, according to the current specification, only the EPS bearer information can be gotten by GTPv2 and the GPRS bearer information cannot be gotten. On the other hand, only the GPRS bearer information can be gotten by GTPv1 and the EPS bearer information cannot be gotten.

Therefore, when the destination exchange SGSN#2 requests to get using a protocol whereby it is not possible to get bearer information stored in the source exchange SGSN#1, there may be a situation in which the bearer information cannot be gotten. For example, in FIG. 15(A), when the source exchange SGSN#1 has an established GPRS bearer for a mobile terminal supporting only GPRS users (that is, supporting only a UMTS/GPRS scheme), if the source exchange SGSN#1 receives a request for getting the bearer information from the destination exchange SGSN#2 using GTPv2, the source exchange SGSN#1 cannot set the GPRS bearer information to be gotten in the signal, and therefore it returns an error, resulting in a problem that the service for the GPRS users is interrupted. Similarly, in FIG. 15 (B), when the source exchange SGSN#1 has an established EPS bearer for EPS users (that is, mobile terminals supporting an LTE scheme), if a request for getting the bearer information is received from the destination exchange SGSN#1 using GTPv1, the source exchange SGSN#2 cannot set the EPS bearer information to be gotten in the signal, and therefore it returns an error, resulting in a problem that the service for the EPS users is interrupted.

The present invention has been implemented in view of the above-described problems and it is an object of the present invention to provide a mobile communication method and an exchange capable of reliably performing a bearer getting processing between a source exchange SGSN and a destination exchange SGSN without causing any service interruption.

### Solution to Problem

An aspect of the present invention includes the steps of: assigning, to a mobile terminal located in a management area of a first exchange, a temporary subscriber identifier indicating a communication path type of a logical communication path established for the mobile terminal, at the first exchange; receiving, from the mobile terminal having moved from the management area of the first exchange to a management area of a second exchange, a location update request signal including the temporary subscriber identifier, at the second exchange; sending, from the second exchange having received the location update request signal to the first exchange, a communication path information request signal for requesting to get communication path information stored in the first exchange, by using a protocol corresponding to the communication path type indicated by the temporary subscriber identifier; and sending, from the first exchange having received the communication path information request signal to the second exchange, a communication path information response signal including the communication path information, by using the same protocol as that of the communication path information request signal.

According to this feature, since the second exchange requests to get the communication path information stored in the first exchange by using a protocol corresponding to the communication path type indicated by the temporary subscriber identifier, it is possible to reliably perform a getting processing of the communication path information between the first exchange and the second exchange, and thereby prevent service interruption.

Another aspect of the present invention includes the steps of: sending, in response to an attach request signal from a mobile terminal located in a management area of a first exchange, an attach response signal including a communication path type identifier indicating a communication path type of a logical communication path established for the mobile terminal, at the first exchange; receiving, from a mobile terminal having moved from the management area of the first exchange to a management area of a second exchange, a location update request signal including the communication path type identifier, at the second exchange; sending, from the second exchange having received the location update request signal to the first exchange, a communication path information request signal for requesting to get the communication path information stored in the first exchange to the first exchange, by using a protocol corresponding to the communication path type indicated by the communication path type identifier; and sending, from the first exchange having received the communication path information request signal to the second exchange, a communication path information response signal including the communication path information, by using the same protocol as that of the communication path information request signal.

According to this feature, since the second exchange requests to get the communication path information stored in the first exchange using the protocol corresponding to the communication path type indicated by the communication path type identifier, it is possible to reliably perform takeover processing of the communication path information between the first exchange and the second exchange, and thereby prevent service interruption.

### Technical Advantages of Invention

According to the present invention, bearer takeover processing is reliably performed between the source exchange SGSN and the destination exchange SGSN, and it is thereby possible to prevent service interruption.

### BRIEF DESCRIPTION OF DRAWINGS

FIG. 1 is a schematic configuration diagram of a mobile communication system according to a first embodiment;

FIG. 2 is a function block diagram of an exchange according to the first embodiment;

FIG. 3 is a configuration example of P-TMSI according to the first embodiment;

FIG. 4 is a schematic diagram indicating operation at the time of attach according to the first embodiment;

FIG. 5 is a sequence diagram indicating operation at the time of attach according to the first embodiment;

FIG. 6 is a schematic diagram showing operation during a moving between exchanges SGSN according to the first embodiment;

FIG. 7 is a sequence diagram showing operation during a moving between exchanges SGSN according to the first embodiment;

FIG. 8 is a schematic diagram showing operation upon PS originating according to the first embodiment;

FIG. 9 is a sequence diagram showing operation upon PS originating according to the first embodiment;

FIG. 10 is a sequence diagram showing operation upon attach according to a second embodiment;

FIG. 11 is a sequence diagram showing operation when terminal capability is changed according to the second embodiment;

FIG. 12 is a sequence diagram showing operation when a contract is changed according to the second embodiment;

FIG. 13 is a diagram illustrating a configuration example of an attach response signal according to a third embodiment;

FIG. 14 is a sequence diagram showing operation upon attach according to the third embodiment; and

FIG. 15 is a sequence diagram showing operation during a moving between conventional exchanges SGSN.

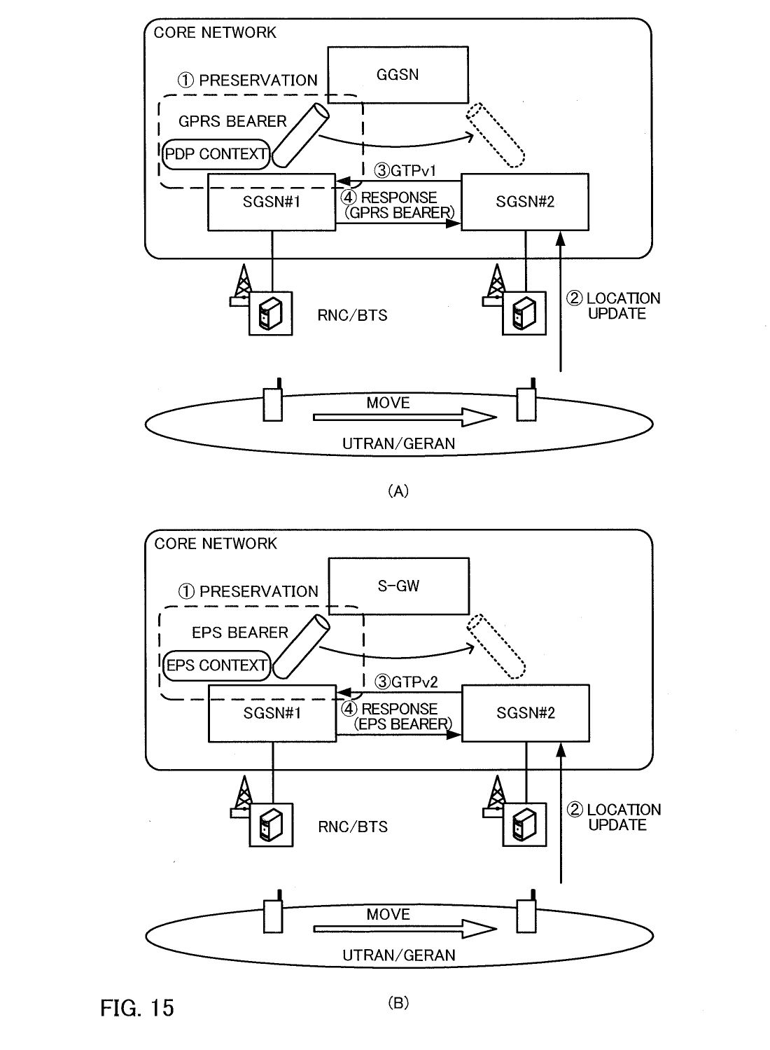

### DESCRIPTION OF EMBODIMENTS

Hereinafter, embodiments of the present invention will be described in detail with reference to the accompanying drawings.

### First Embodiment

### Configuration of Mobile Communication System

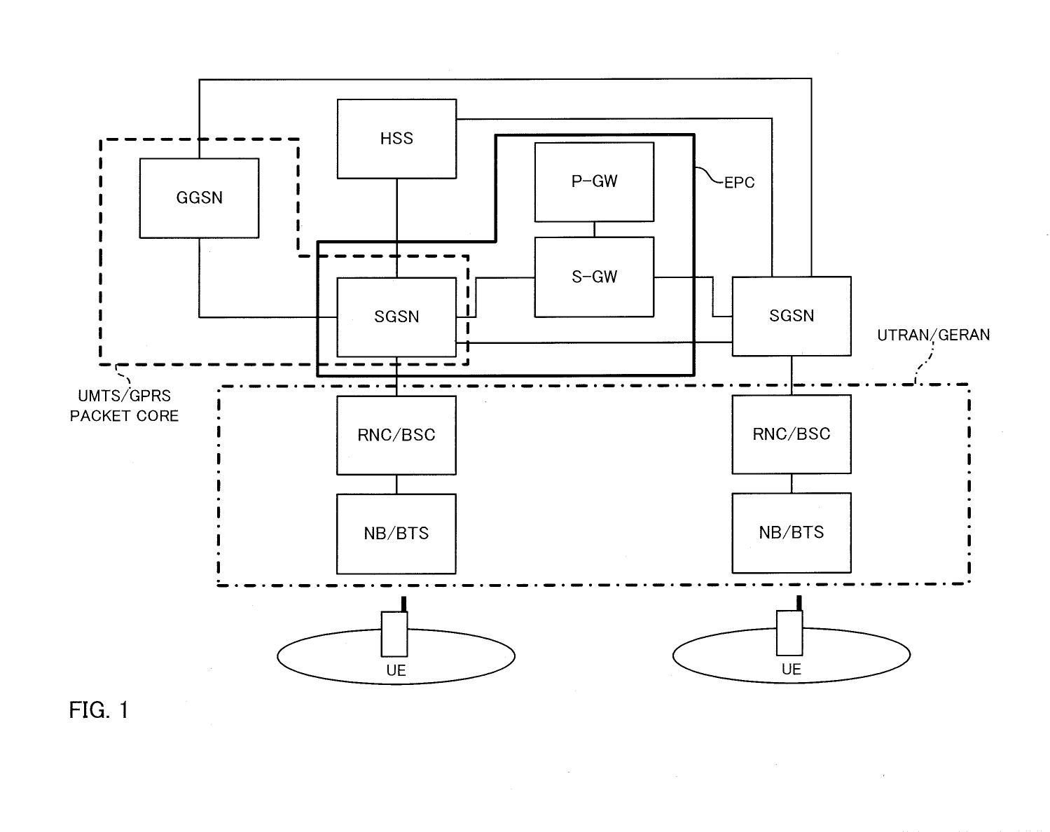

FIG. 1 is a diagram illustrating a configuration of a mobile communication system. The mobile communication system is configured by including a mobile terminal UE, a UTRAN/GERAN that performs wireless UMTS/GPRS-based communication with the mobile terminal UE, a UMTS/GPRS packet core network that provides a UMTS/GPRS-based packet switching service, an EPC network that provides an LTE-based packet switching service, an exchange SGSN that belongs to both the UMTS/GPRS packet core network and the EPC network, and a subscriber management server HSS.

In the present embodiment, the mobile terminal UE is intended for a radio communication terminal supporting only the UMTS/GPRS scheme and a radio communication terminal supporting both the UMTS/GPRS scheme and LTE scheme.

The UTRAN/GERAN is configured by including a radio base station NB/BTS and a radio control apparatus RNC/BTS that controls the radio base station NB/BTS. The radio base station NB/BTS forms a cell and sends/receives a signal to/from the mobile terminal UE located in the cell via a radio channel. The radio control apparatus RNC/BTS controls the radio base station NB/BIS and allocates a radio channel to the mobile terminal UE or the like.

The UMTS/GPRS packet core network is configured by including a packet gateway GGSN. The packet gateway GGSN establishes a GPRS bearer with the mobile terminal UE supporting only the UMTS/GPRS scheme via an exchange SGSN. Here, the GPRS bearer is a logical communication path that transfers a user packet according to the UMTS/GPRS scheme.

The EPC network is configured by including a serving gateway S-GW and a packet gateway P-GW. The packet gateway P-GW establishes an EPS bearer with the mobile terminal UE supporting the LTE scheme via the exchange SGSN and the serving gateway S-GW. Here, the EPS bearer is a logical communication path that transfers a user packet according to the LTE scheme.

The exchange SGSN is connected to the packet gateway GGSN of the UMTS/GPRS packet core network via a Gn interface and also connected to the serving gateway S-GW of the EPC network via an S4 interface. The exchange SGSN controls the GPRS bearer established with the packet gateway GGSN or controls the EPS bearer established with the packet gateway P-GW via the serving gateway S-GW depending on whether the mobile terminal UE supports the LTE scheme or not.

Furthermore, the exchange SGSN can use both GTPv1 (GPRS Tunneling Protocol, version 1) and GTPv2 (GPRS Tunneling Protocol, version 2). Here, GTPv1 is a protocol for controlling the GPRS bearer and used to send/receive a signal between the exchange SGSN and the packet gateway GGSN, and to send/receive a signal between the source exchange SGSN and the destination exchange SGSN of the mobile terminal UE. On the other hand, GTPv2 is a protocol for controlling EPS and used to send/receive a signal between the exchange SGSN and the serving gateway S-GW and to send/receive a signal between the source exchange SGSN and the destination exchange SGSN of the mobile terminal UE.

Furthermore, the exchange SGSN performs location update processing on the mobile terminal UE for a subscriber management server HSS. The subscriber management server HSS manages contract information and a location registration area of the mobile terminal UE.

### <Configuration of Exchange SGSN>

Next, a configuration of the exchange SGSN according to the first embodiment will be described. The mobile terminal UE has hardware including a communication interface, processor, memory, display and input key, and the memory stores software modules executed by a processor. The functions which will be described below may be implemented by the above-described hardware or may be implemented by the software modules executed by the processor or may be implemented by a combination of both.

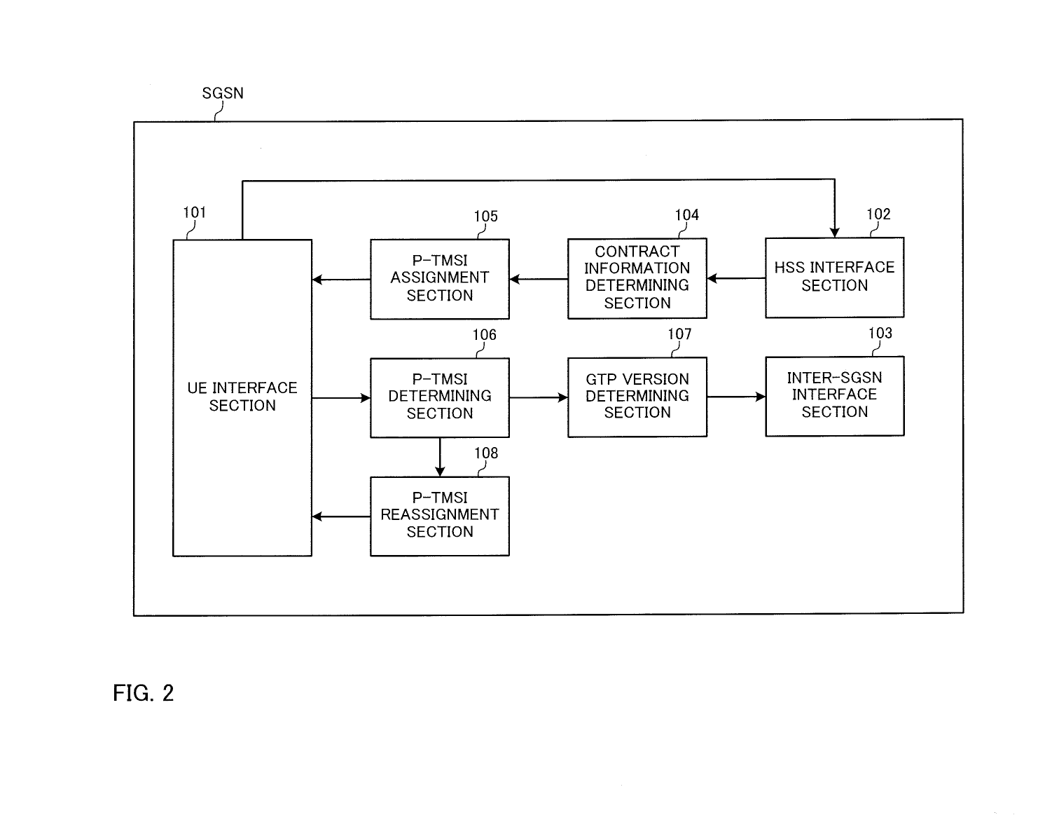

FIG. 2 is a function block diagram of the exchange SGSN according to the first embodiment. As shown in FIG. 2, the exchange SGSN is constructed of a UE interface section 101, an HSS interface section 102, an inter-SGSN interface section 103, a contract information determining section 104, a P-TMSI assignment section 105, a P-TMSI determining section 106, a GTP version determining section 107 and a P-TMSI reassignment section 108.

The UE interface section 101 sends/receives a signal to/from the mobile terminal UE using an Iu interface. To be more specific, the UE interface section 101 receives an attach request signal, a location update request signal, a PS originating signal or the like from the mobile terminal UE. Furthermore, the UE interface section 101 sends an attach response signal, location update response signal, P-TMSI reassignment signal or the like which will be described later to the mobile terminal UE.

The HSS interface section 102 sends/receives a signal to/from the subscriber management server HSS using a Gr/S6d interface. To be more specific, the HSS interface section 102 sends a location update request signal which will be described later to the subscriber management server HSS and receives a location update response signal from the subscriber management server HSS.

The inter-SGSN interface section 103 sends/receives a signal to/from another exchange SGSN using a Gn/S16 interface. To be more specific, the inter-SGSN interface section 103 sends a bearer information request signal (communication path information request signal) to the source exchange SGSN of the mobile terminal UE according to the determination result of the GTP version determining section 107 which will be described later using GTPv1 or GTPv2. Furthermore, the inter-SGSN interface section 103 receives a bearer information response signal (communication path information response signal) from the source exchange SGSN of the mobile terminal UE using GTPv1 or GTPv2.

The contract information determining section 104 determines whether contract information of the mobile terminal UE included in the location update response signal received by the HSS interface section 102 is “GPRS only (GPRS contract only)” or “EPS+GPRS (EPS contract and GPRS contract).”

The P-TMSI assignment section 105 assigns a P-TMSI indicating a bearer type (communication path type) corresponding to contract information of the mobile terminal UE to the mobile terminal UE. Here, P-TMSI (temporary subscriber identifier) is an identifier of the mobile terminal UE temporarily assigned in response to an attach request from the mobile terminal UE. To be more specific, when the contract information determining section 104 determines that the contract information is “GPRS only,” the P-TMSI assignment section 105 assigns a P-TMSI indicating the use of the GPRS bearer to the mobile terminal UE. On the other hand, when the contract information determining section 104 determines that the contract information is “EPS+GPRS,” the P-TMSI assignment section 105 assigns a P-TMSI indicating the use of the EPS bearer to the mobile terminal UE.

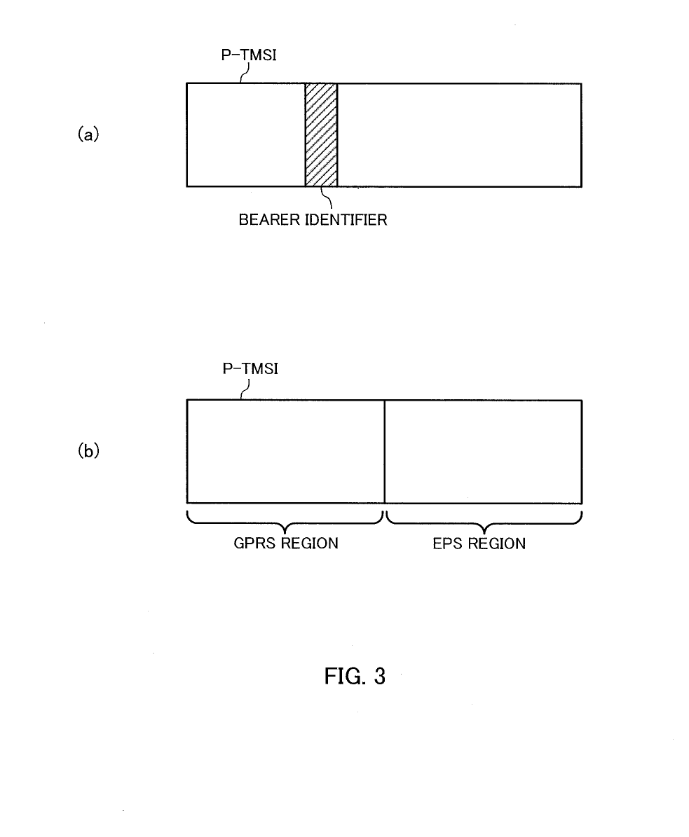

FIG. 3 is a diagram illustrating a configuration example of P-TMSI. In FIG. 3 (a), a predetermined bit constituting P-TMSI is used as a bearer identifier for identifying the bearer type. The P-TMSI assignment section 105 may set “1” or “0” in the bearer identifier according to the determination result of the contract information to thereby assign P-TMSI indicating that the GPRS bearer or EPS bearer is used to the mobile terminal UE. The bearer identifier may be set to “1 (GPRS bearer is used)” or “0 (EPS bearer is used)” or may be set to “1 (EPS bearer is used)” or “0 (GPRS bearer is used).”

In FIG. 3 (b), P-TMSI is divided into a GPRS region and an EPS region. The P-TMSI assignment section 105 may set a value in one of the GPRS region and EPS region according to the determination result of the contract information to thereby assign P-TMSI indicating that the GPRS bearer or EPS bearer is used to the mobile terminal UE. The positions of the GPRS region and EPS region are not limited to the positions shown in FIG. 3 (b).

The P-TMSI determining section 106 determines the bearer type of the bearer used by the mobile terminal UE according to P-TMSI included in the location update request signal received by the UE interface section 101. To be more specific, the P-TMSI determining section 106 determines the bearer type depending on which of “1” or “0” the bearer identifier shown in FIG. 3 (a) indicates or in which of the GPRS region or EPS region shown in FIG. 3 (b) the value is set.

The GTP version determining section 107 determines which version of GTP is used to send the bearer information request signal from the inter-SGSN interface section 103. To be more specific, when the P-TMSI determining section 106 determines that the bearer type is the GPRS bearer, the GTP version determining section 107 determines to use GTPv1 by which the GPRS bearer information (PDP context) can be received. On the other hand, when the P-TMSI determining section 106 determines that the bearer type is the EPS bearer, the GTP version determining section 107 determines to use GTPv2 by which the EPS bearer information (EPS context) can be received.

When the bearer type determined by the P-TMSI determining section 106 is different from the bearer type of the established bearer (established communication path) that the mobile terminal UE should establish, the P-TMSI reassignment section 108 reassigns the P-TMSI that matches the bearer type of the establish bearer to the mobile terminal UE.

### <Operation of Mobile Communication System>

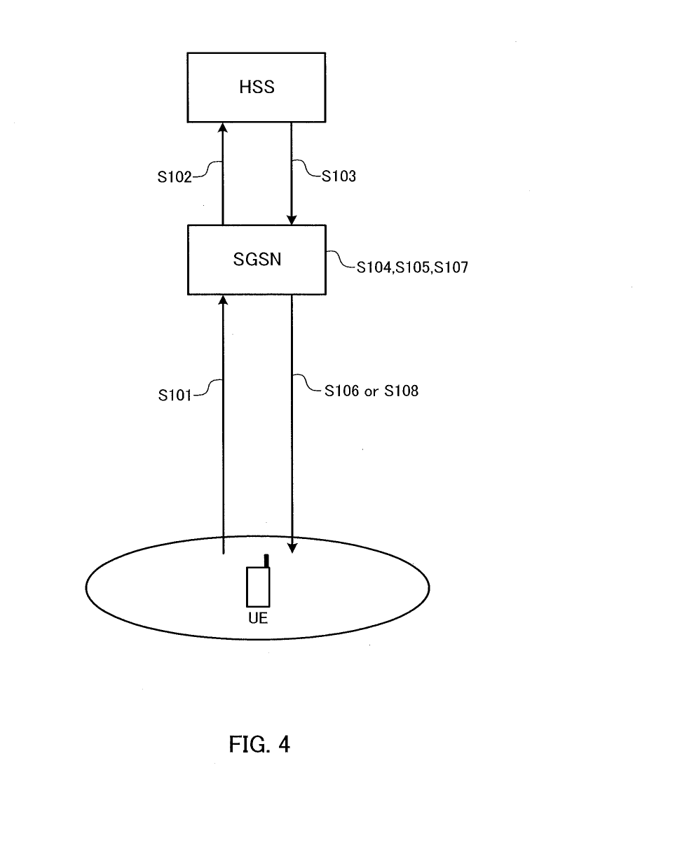

Next, operation of the mobile communication system configured as shown above will be described with reference to FIGS. 4 to 9. In FIGS. 4 and 5, FIGS. 6 and 7, and FIGS. 8 and 9, suppose identical reference numerals denote identical steps. Furthermore, in FIGS. 4 to 9, suppose a signal between the mobile terminal UE and the exchange SGSN is sent/received via the radio base station NB/BTS and the radio control apparatus RNC/BSC (not shown).

### (1-1) Attach Operation

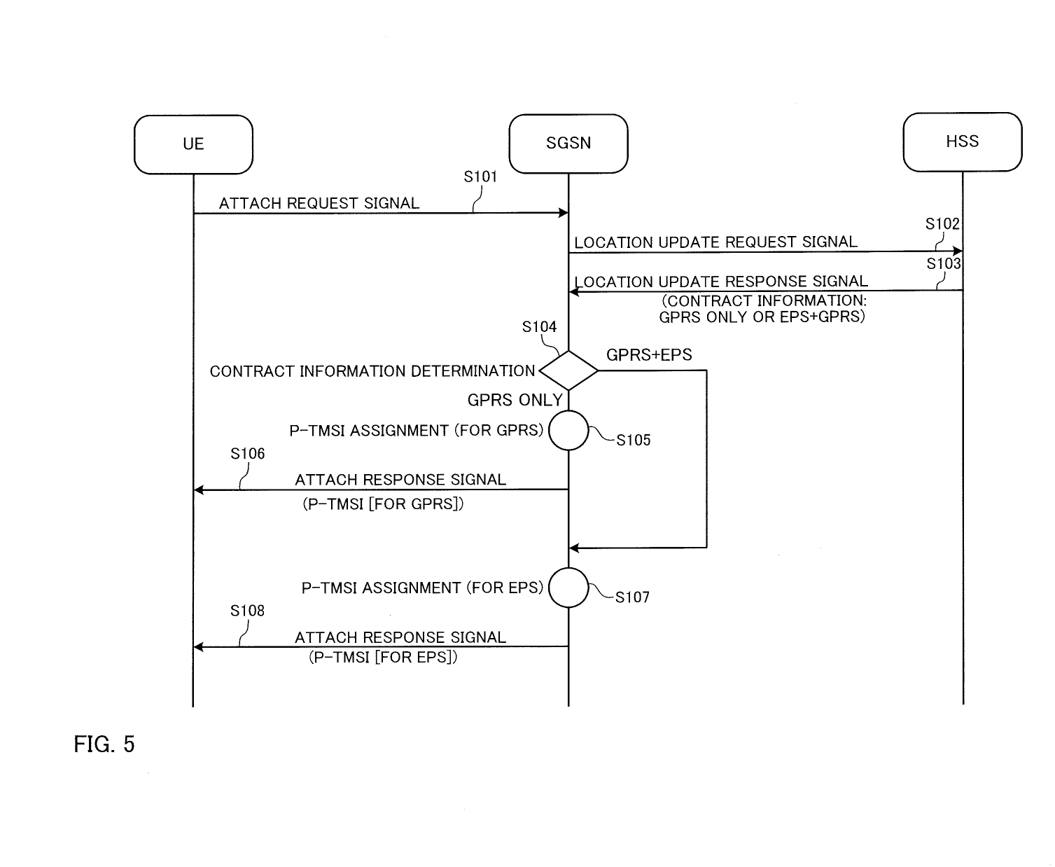

Operation of the mobile communication system according to the first embodiment upon attach will be described with reference to FIGS. 4 and 5. FIGS. 4 and 5 are a schematic diagram and a sequence diagram showing operation of the mobile communication system according to the first embodiment upon attach. The “attach” refers to processing of performing location update of the mobile terminal UE and assigning P-TMSI to the mobile terminal UE.

As shown in FIGS. 4 and 5, the mobile terminal UE located in a cell sends an attach request signal for requesting attach to the exchange SGSN (step S101). The exchange SGSN sends a location update request signal for requesting location update of the mobile terminal UE to the subscriber management server HSS in response to the attach request signal from the mobile terminal UE (step S102). In response to the location update request signal from the exchange SGSN, the subscriber management server HSS performs location update processing with reference to contract information of the mobile terminal UE and transmits a location update response signal including the contract information to the exchange SGSN (step S103).

The exchange SGSN determines whether the contract information of the mobile terminal UE included in the location update response signal from the subscriber management server HSS is “GPRS only (GPRS contract only)” or “EPS+GPRS (EPS contract and GPRS contract)” (step S104).

When the contract information is “GPRS only,” the exchange SGSN assigns a P-TMSI indicating the use of the GPRS bearer to the mobile terminal UE (step S105). For example, the exchange SGSN assigns a P-TMSI for which the bearer identifier shown in FIG. 3(a) is set to “1 (GPRS bearer is used)” or P-TMSI for which a value is set in the GPRS region shown in FIG. 3(b) to the mobile terminal UE. The exchange SGSN sends an attach response signal including the assigned P-TMSI to the mobile terminal UE (step S106).

When the contract information is “EPS+GPRS,” the exchange SGSN assigns a P-TMSI indicating the use of the EPS bearer to the mobile terminal UE (step S107). For example, the exchange SGSN assigns a P-TMSI for which the bearer identifier shown in FIG. 3(a) is set to “0 (EPS bearer is used)” or assigns a P-TMSI for which a value is set in the EPS region shown in FIG. 3(b) to the mobile terminal UE. The exchange SGSN sends an attach response signal including P-TMSI to the mobile terminal UE (step S108).

### (1-2) Inter-SGSN Moving Operation

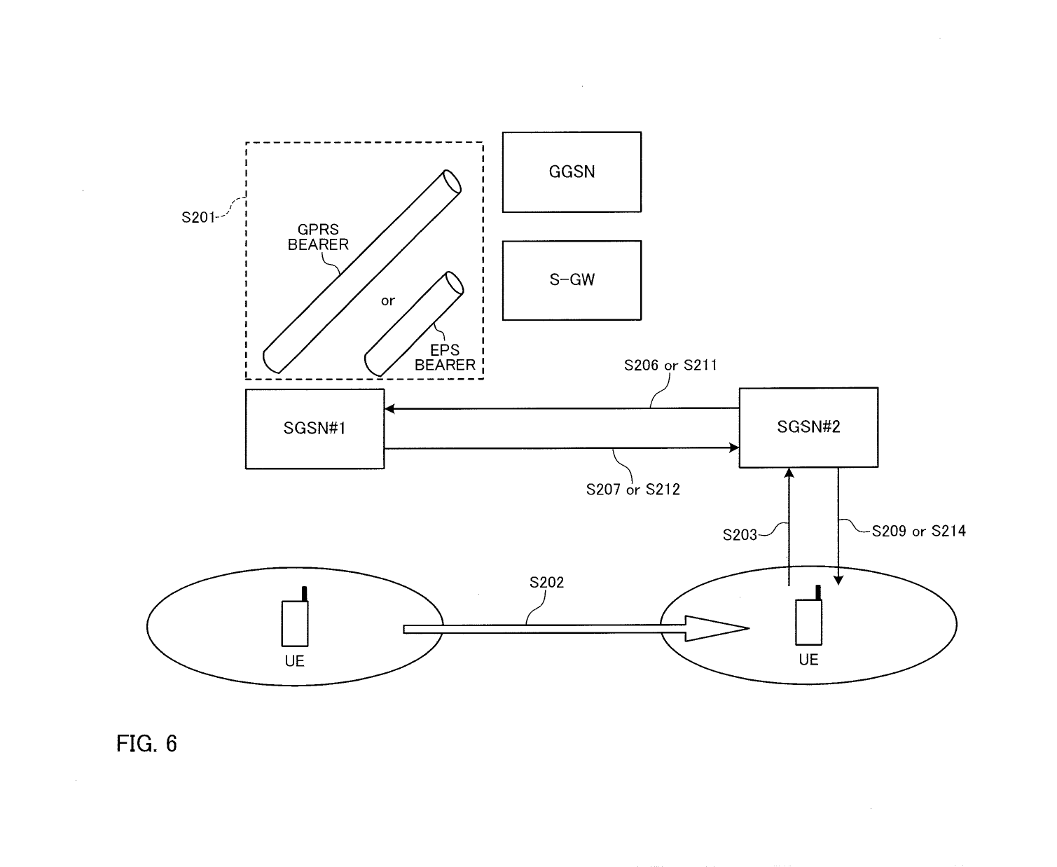

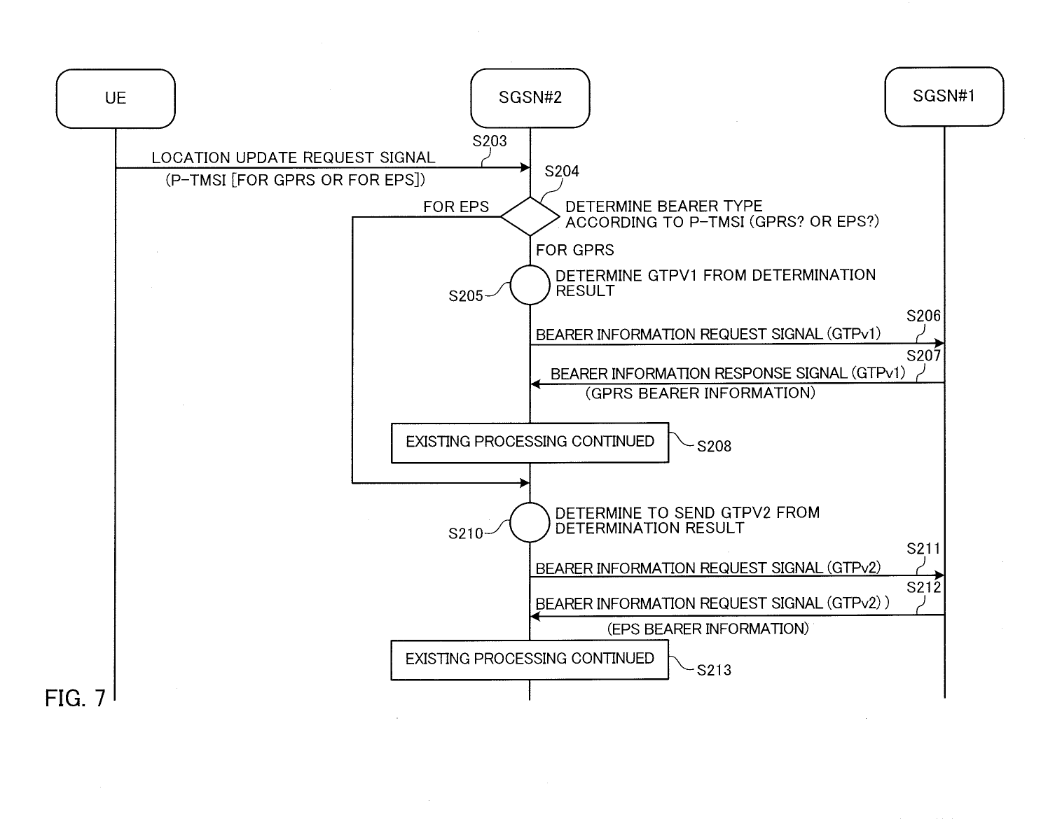

Operation of the mobile communication system according to the first embodiment when a mobile terminal UE in idle mode moves between the exchanges SGSN will be described with reference to FIGS. 6 and 7. FIGS. 6 and 7 are a schematic diagram and a sequence diagram showing operation of the mobile communication system according to the first embodiment when a mobile terminal UE in idle mode moves from the management area of the exchange SGSN#1 (first exchange) to the management area of the exchange SGSN#2 (second exchange).

As shown in FIG. 6, the exchange SGSN#1 maintains the GPRS bearer with the packet gateway GGSN or maintains the EPS bearer with a packet gateway P-GW (not shown) via the serving gateway S-GW (step S201). To be more specific, the exchange SGSN#1 maintains the GPRS bearer with the packet gateway GGSN using a preservation function and stores GPRS bearer information (PDP context) indicating information on the GPRS bearer. Alternatively, the exchange SGSN#1 maintains the EPS bearer with the packet gateway P-GW (not shown) via the serving gateway S-GW using the preservation function and stores EPS bearer information (EPS context) indicating information on the EPS bearer.

The mobile terminal UE in idle mode moves from the management area of the exchange SGSN#1 to the management area of the exchange SGSN#2 (step S202). As shown in FIGS. 6 and 7, the mobile terminal UE that has moved to the management area of the exchange SGSN#2 sends a location update request signal including P-TMSI assigned by the exchange SGSN#1 to the exchange SGSN#2 (step S203). The “location update request signal” is intended to request the location update of the mobile terminal UE to the location update area after moving.

The exchange SGSN#2 determines the bearer type according to the P-TMSI included in the location update request signal from the mobile terminal UE (step S204). To be more specific, the exchange SGSN#2 determines the bearer type depending on whether the bearer identifier shown in FIG. 3(a) is “1 (GPRS bearer is used)” or “0 (EPS bearer is used)” or depending on in which of the GPRS region or EPS region shown in FIG. 3(b) a value is set.

When the bearer type is a GPRS bearer, the exchange SGSN#2 determines to send a bearer information request signal (communication path information request signal) for requesting GPRS bearer information using GTPv1 (step S205). The exchange SGSN#2 sends the bearer information request signal for requesting GPRS bearer information to the exchange SGSN#1 using GTPv1 (step S206). The exchange SGSN#1 sends a bearer information response signal including the GPRS bearer information to the exchange SGSN#2 using GTPv1 in response to the bearer information request signal from the exchange SGSN#2 (step S207).

The exchange SGSN#2 performs processing of setting the GPRS bearer with the packet gateway GGSN based on the GPRS bearer information from the exchange SGSN#1 and also performs processing of location update of the mobile terminal UE with the subscriber management server HSS (not shown) (step S208). The exchange SGSN#2 sends a location update response signal indicating that the location update has been completed (step S209 in FIG. 6).

When the bearer type is an EPS bearer, the exchange SGSN#2 determines to send a bearer information request signal for requesting EPS bearer information using GTPv2 (step S210). The exchange SGSN#2 sends the bearer information request signal for requesting the EPS bearer information to the exchange SGSN#1 via GTPv2 (step S211). The exchange SGSN#1 sends a bearer information response signal including the EPS bearer information to the exchange SGSN#2 using GTPv2 in response to the bearer information request signal from the exchange SGSN#2 (step S212).

The exchange SGSN#2 performs processing of setting the EPS bearer with the serving gateway S-GW based on the EPS bearer information from the exchange SGSN#1 and also performs processing of location update of the mobile terminal UE with the subscriber management server HSS (not shown) (step S213). The exchange SGSN#2 sends a location update response signal indicating that the location update has been completed (step S214 in FIG. 6).

### (1-3) PS Originating Operation

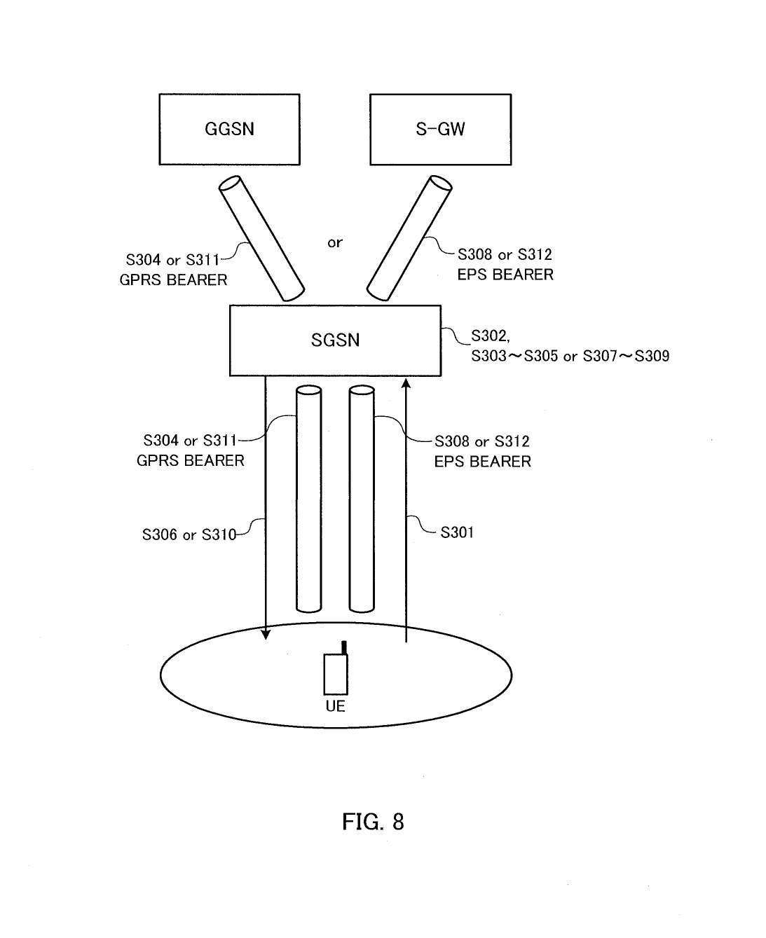

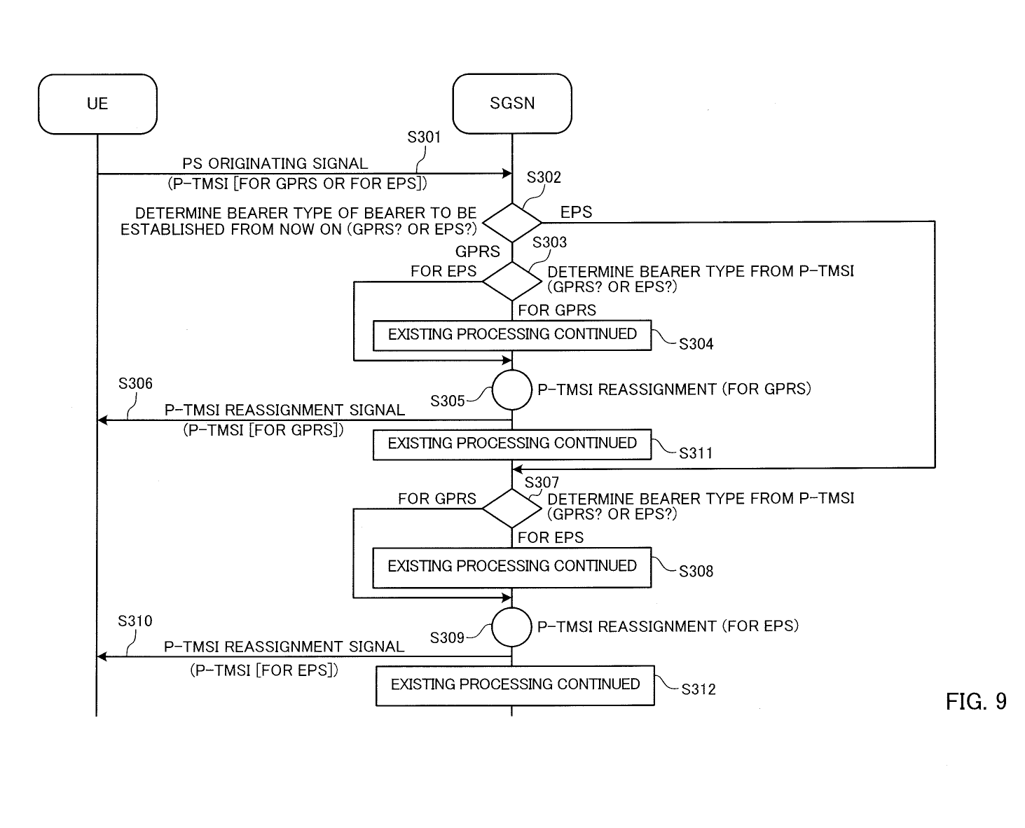

Operation of the mobile communication system according to the first embodiment when the mobile terminal UE having established a GPRS bearer or EPS bearer performs originating will be described with reference to FIGS. 8 and 9. FIGS. 8 and 9 are a schematic diagram and a sequence diagram showing operation of the mobile communication system according to the first embodiment when the mobile terminal UE that has established the GPRS bearer or EPS bearer performs originating.

In FIGS. 8 and 9, the mobile terminal UE sends a PS originating signal to the exchange SGSN to request originating through packet switching (step S301). The PS originating signal includes the P-TMSI assigned through the aforementioned attach operation.

The exchange SGSN determines the bearer type of a bearer to be established from now on according to the PS originating signal from the mobile terminal UE (step S302). To be more specific, the exchange SGSN determines whether to establish the GPRS bearer or EPS bearer based on the aforementioned contract information or terminal capability information. When the bearer type of the bearer to be established is the GPRS bearer, the exchange SGSN determines the bearer type according to the P-TMSI included in the PS originating signal received in step S301 (step S303). The method of determining the bearer type according to the P-TMSI is similar to that in step S204 of FIG. 7. When the bearer type shown in the P-TMSI is the GPRS bearer, the exchange SGSN continues the GPRS bearer establishment processing on the mobile terminal UE (step S304).

On the other hand, when the bearer type indicated by the P-TMSI is the EPS bearer, the exchange SGSN assigns the P-TMSI indicating the use of the GPRS bearer to the mobile terminal UE (step S305). For example, the exchange SGSN assigns a P-TMSI for which the bearer identifier shown in FIG. 3(a) is set to “1 (GPRS bearer is used)” or P-TMSI for which a value is set in the GPRS region shown in FIG. 3(b) to the mobile terminal UE. The exchange SGSN sends P-TMSI reassignment signal including the assigned P-TMSI to the mobile terminal UE (step S306). Furthermore, the exchange SGSN continues the GPRS bearer establishment processing of the mobile terminal UE (step S311).

When the bearer type of the bearer to be established is the EPS bearer, the exchange SGSN determines the bearer type according to the P-TMSI included in the PS originating signal received in S301 as in the case of step S303 (step S307). When the bearer type indicated by the P-TMSI is the EPS bearer, the exchange SGSN continues the EPS bearer establishment processing of the mobile terminal UE (step S308).

On the other hand, when the bearer type indicated by the P-TMSI is the GPRS bearer, the exchange SGSN assigns a P-TMSI indicating the use of the EPS bearer to the mobile terminal UE (step S309). For example, the exchange SGSN assigns a P-TMSI for which the bearer identifier shown in FIG. 3(a) is set to “0 (EPS bearer is used)” or P-TMSI for which a value is set in the EPS region shown in FIG. 3(b) to the mobile terminal UE. The exchange SGSN sends a P-TMSI reassignment signal including the assigned P-TMSI to the mobile terminal UE (step S310). Furthermore, the exchange SGSN continues the EPS bearer establishment processing of the mobile terminal UE (step S312).

### <Operation/Effect>

According to the mobile communication system according to the first embodiment, the destination exchange SGSN#2 of the mobile terminal UE requests to get bearer information stored in the source exchange SGSN#1 using a protocol corresponding to the bearer type indicated by P-TMSI, and it is thereby possible to reliably perform getting processing of the bearer information between the source exchange SGSN#1 and the destination exchange SGSN#2 and prevent service interruption.

### Second Embodiment

Next, a mobile communication system according to a second embodiment will be described mainly on differences from the first embodiment. The mobile communication system according to the second embodiment is different from the first embodiment in that the exchange SGSN assigns a P-TMSI to a mobile terminal UE based on terminal capability information of the mobile terminal UE in addition to contract information of the mobile terminal UE.

### <Configuration of Exchange SGSN>

The P-TMSI assignment section 105 assigns a P-TMSI to the mobile terminal UE based on terminal capability information of the mobile terminal UE in addition to contract information of the mobile terminal UE. Here, the terminal capability information refers to whether or not the mobile terminal UE supports an LTE scheme.

To be more specific, when the contract information determining section 104 determines that the contract information is “EPS+GPRS” and the mobile terminal UE supports the LTE scheme, the P-TMSI assignment section 105 assigns a P-TMSI indicating the use of the EPS bearer to the mobile terminal UE. On the other hand, even when the contract information determining section 104 determines that the contract information is “EPS+GPRS,” if the mobile terminal UE does not support the LTE scheme, the P-TMSI assignment section 105 assigns a P-TMSI indicating the use of the GPRS bearer to the mobile terminal UE.

When the bearer type corresponding to the changed terminal capability of the mobile terminal UE is different from the bearer type indicated by the P-TMSI, the P-TMSI reassignment section 108 reassigns the P-TMSI indicating that a bearer corresponding to the changed terminal capability to the mobile terminal UE. For example, although the support or not of the LTE scheme by the mobile terminal UE is changed from the support to no support, if the P-TMSI assigned to the mobile terminal UE indicates the use of the EPS bearer, P-TMSI indicating the use of the GPRS bearer is reassigned to the mobile terminal UE.

Furthermore, when the bearer type corresponding to the changed terminal capability of the mobile terminal UE matches the bearer type corresponding to the contract information of the mobile terminal UE, the P-TMSI reassignment section 108 reassigns the P-TMSI indicating the use of a bearer corresponding to the changed terminal capability to the mobile terminal UE. For example, although the support or not of the LTE scheme by the mobile terminal UE is changed from no support to support and if the contract information of the mobile terminal UE is “GPRS+EPS,” the P-TMSI assignment section 105 reassigns the P-TMSI indicating the use of the EPS bearer to the mobile terminal UE.

Furthermore, when the bearer type corresponding to the changed contract information of the mobile terminal UE is different from the bearer type indicated by the P-TMSI, the P-TMSI reassignment section 108 reassigns the P-TMSI indicating the use of the bearer corresponding to the changed contract information to the mobile terminal UE. For example, although the contract information of the mobile terminal UE is changed from “GPRS+EPS” to “GPRS only,” if the P-TMSI assigned to the mobile terminal UE indicates the use of the EPS bearer, the P-TMSI assignment section 105 reassigns the P-TMSI indicating the use of the GPRS bearer to the mobile terminal UE.

On the other hand, when the bearer type corresponding to the changed contract information of the mobile terminal UE matches the bearer type corresponding to the terminal capability of the mobile terminal UE, the P-TMSI reassignment section 108 reassigns the P-TMSI indicating the use of the bearer corresponding to the changed contract information to the mobile terminal UE. For example, when the contract information of the mobile terminal UE is changed from “GPRS only” to “GPRS+EPS” and the mobile terminal UE supports the LTE scheme, the P-TMSI reassignment section 108 reassigns the P-TMSI indicating the use of the EPS bearer to the mobile terminal UE.

### <Operation of Mobile Communication System>

### (2-1) Attach Operation

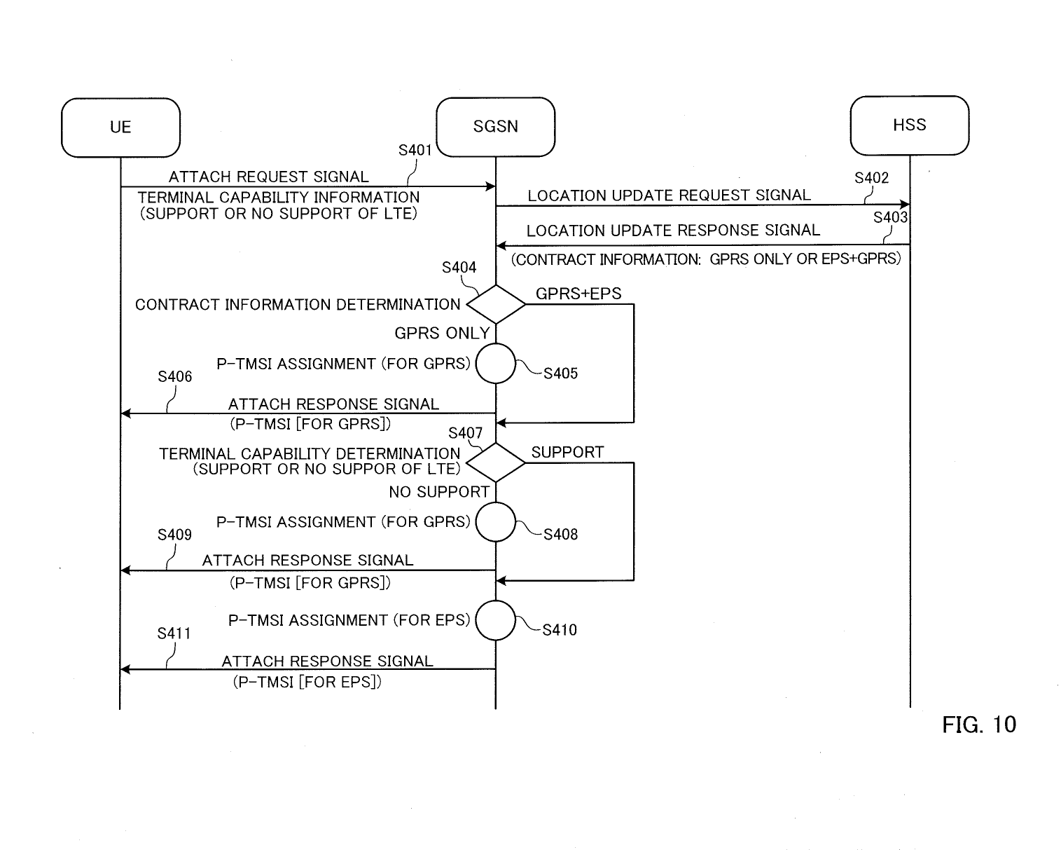

Operation of the mobile communication system according to the second embodiment upon attach will be described mainly on differences from the first embodiment with reference to FIG. 10. FIG. 10 is a sequence diagram showing operation of the mobile communication system according to the second embodiment upon attach.

As shown in FIG. 10, a mobile terminal UE located in a cell sends an attach signal including terminal capability information of the mobile terminal UE to an exchange SGSN (step S401). Since steps S402 to S406 are similar to steps S102 to S106 in FIG. 5, descriptions thereof will be omitted.

When contract information is “EPS+GPRS,” the exchange SGSN determines whether the mobile terminal UE supports the LTE scheme or not according to the terminal capability information included in the attach signal received in step S401 (step S407).

When the mobile terminal UE does not support the LTE scheme, the exchange SGSN assigns a P-TMSI indicating the use of the GPRS bearer to the mobile terminal UE (step S408). A method similar to that in step S105 in FIG. 5 is used as the method of assigning the P-TMSI indicating the use of the GPRS bearer. The exchange SGSN sends an attach response signal including the P-TMSI to the mobile terminal UE (step S409).

When the mobile terminal UE supports the LTE scheme, the exchange SGSN assigns a P-TMSI indicating the use of the EPS bearer to the mobile terminal UE (step S410). A method similar to that in step S107 in FIG. 5 is used as the method of assigning the P-TMSI indicating the use of the EPS bearer. The exchange SGSN sends an attach response signal including the assigned P-TMSI to the mobile terminal UE (step S411).

### (2-2) Terminal Capability Changing Operation

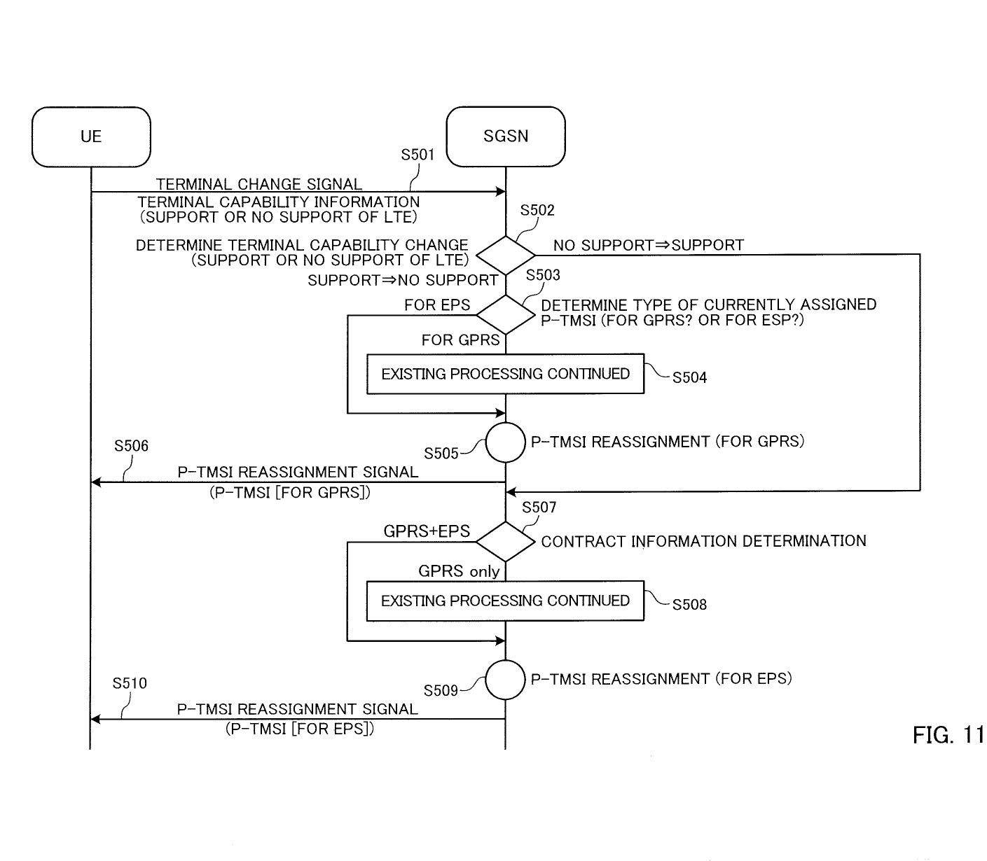

Operation of the mobile communication system according to the second embodiment when the terminal capability of the mobile terminal UE is changed will be described with reference to FIG. 11. FIG. 11 is a sequence diagram showing operation of the mobile communication system according to the second embodiment when the terminal capability information of the mobile terminal UE is changed.

In FIG. 11, in the above-described attach operation, suppose the exchange SGSN stores the terminal capability information reported from the mobile terminal UE, the contract information of the mobile terminal UE reported from the subscriber management server HSS and the P-TMSI assigned to the mobile terminal UE.

As shown in FIG. 11, the mobile terminal UE sends a terminal change signal including the changed terminal capability information to the exchange SGSN (step S501). Here, the terminal change signal is intended to report the change in the terminal capability of the mobile terminal UE.

The exchange SGSN determines how the support or not of the LTE scheme by the mobile terminal UE has changed based on the terminal capability information of the mobile terminal UE received in step S501 and the stored terminal capability information of the mobile terminal UE (step S502).

When the support or not of the LTE scheme is changed from support to no support, the exchange SGSN determines the bearer type according to the P-TMSI assigned to the mobile terminal UE (step S503). When the bearer type is a GPRS bearer, the processing is continued using the already assigned P-TMSI (for GPRS) (step S504). On the other hand, when the bearer type is an EPS bearer, the P-TMSI indicating the use of the GPRS bearer is assigned to the mobile terminal UE (step S505). The exchange SGSN sends a P-TMSI reassignment signal including the assigned P-TMSI to the mobile terminal UE (step S506).

When the support or not of the LTE scheme is changed from no support to support, the exchange SGSN determines the contract information of the mobile terminal UE (step S507). When the contract information is “GPRS only,” the processing is continued using the already assigned P-TMSI (for GPRS) (step S508). On the other hand, when the contract information is “EPS+GPRS,” the exchange SGSN assigns a P-TMSI indicating the use of the EPS bearer to the mobile terminal UE (step S509). The exchange SGSN sends a P-TMSI reassignment signal including the assigned P-TMSI to the mobile terminal UE (step S510).

### (2-3) Contract Change Operation

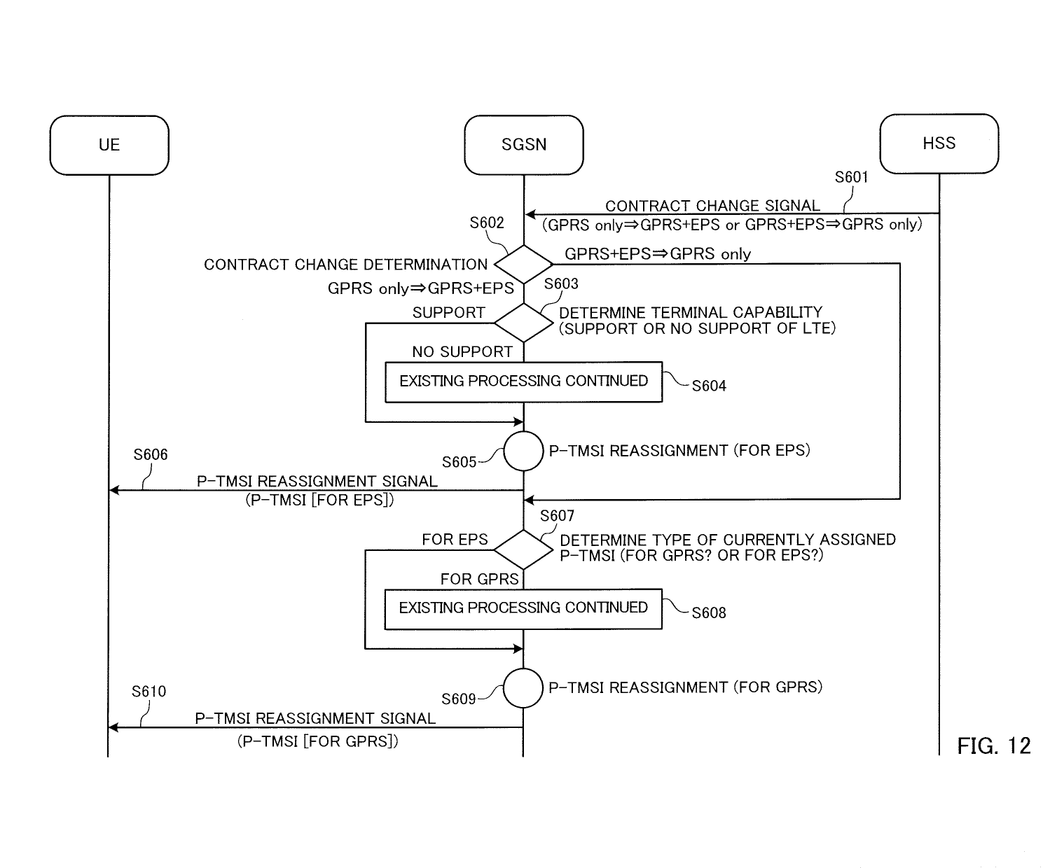

Operation of the mobile communication system according to the second embodiment when the contract information of the mobile terminal UE is changed will be described with reference to FIG. 12. FIG. 12 is a sequence diagram showing operation of the mobile communication system according to the second embodiment when the contract information of the mobile terminal UE is changed.

In FIG. 12, in the above-described attach operation, suppose the exchange SGSN stores the terminal capability information reported from the mobile terminal UE, the contract information of the mobile terminal UE reported from the subscriber management server HSS and the P-TMSI assigned to the mobile terminal UE.

As shown in FIG. 12, the subscriber management server HSS sends a contract change signal including the changed contract information to the exchange SGSN (step S601). Here, the contract change signal is intended to report a change in the contract information of the mobile terminal UE.

The exchange SGSN determines how the contract information of the mobile terminal UE has been changed based on the contract information of the mobile terminal UE received in step S601 and the stored contract information of the mobile terminal UE (step S602).

When the contract information is changed from “GPRS only” to “GPRS+EPS,” the exchange SGSN determines whether or not the mobile terminal UE supports the LTE scheme according to the stored terminal capability information of the mobile terminal UE (step S603). When the mobile terminal UE does not support the LTE scheme, the processing is continued using the already assigned P-TMSI (for GPRS) (step S604). On the other hand, when the mobile terminal UE supports the LTE scheme, a P-TMSI indicating the use of the EPS bearer is assigned to the mobile terminal UE (step S605). The exchange SGSN sends a P-TMSI reassignment signal including the assigned P-TMSI to the mobile terminal UE (step S606).

When the contract information is changed from “GPRS+EPS” to “GPRS only,” the exchange SGSN determines the bearer type according to the P-TMSI assigned to the mobile terminal UE (step S607). When the bearer type is a GPRS bearer, the exchange SGSN continues the processing using the already assigned P-TMSI (for GPRS) (step S608). On the other hand, when the bearer type is an EPS bearer, the exchange SGSN assigns a P-TMSI indicating the use of the GPRS bearer to the mobile terminal UE (step S609). The exchange SGSN sends a P-TMSI reassignment signal including the assigned P-TMSI to the mobile terminal UE (step S610).

### <Operation/Effect>

According to the mobile communication system according to the second embodiment, the exchange SGSN assigns a P-TMSI indicating the use of one of the GPRS bearer and EPS bearer based on not only the contract information of the mobile terminal UE but also whether or not the mobile terminal UE supports the LTE scheme, and therefore the destination exchange SGSN of the mobile terminal UE can request to get the bearer information stored in the source exchange SGSN using a more appropriate protocol. As a result, it is possible to prevent service interruption.

### Third Embodiment

Next, a mobile communication system according to a third embodiment will be described mainly on differences from the first embodiment. The mobile communication system according to the third embodiment is different from the first embodiment in that it is provided with a bearer identifier (new bit) to identify a bearer used by a mobile terminal UE aside from a P-TMSI.

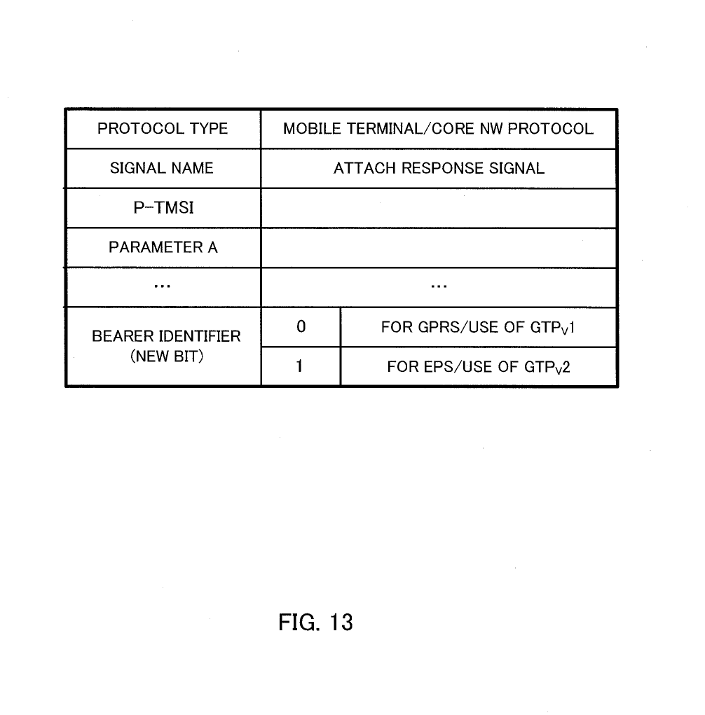

The UE interface section 101 sends an attach response signal including a bearer identifier (new bit) to identify a bearer used by the mobile terminal UE to the mobile terminal UE based on the determination result of the contract information determining section 104. FIG. 13 is a diagram illustrating an example of format of the attach response signal. As shown in FIG. 13, the attach response signal is newly provided with a bearer identifier (new bit) aside from the P-TMSI. The bearer identifier may be set to “1 (GPRS bearer is used)” or “0 (EPS bearer is used)” or on the contrary “1 (EPS bearer is used)” or “0 (GPRS bearer is used).”

Furthermore, the UE interface section 101 may also receive a location update request signal including the above-described bearer identifier (new bit). In such a case, the GTP version determining section 107 determines to send a bearer information request signal using GTPv1 by which the GPRS bearer information can be received or using GTPv2 by which the EPS bearer information can be received based on the bearer identifier.

### <Operation of Mobile Communication System>

### (3-1) Attach Operation

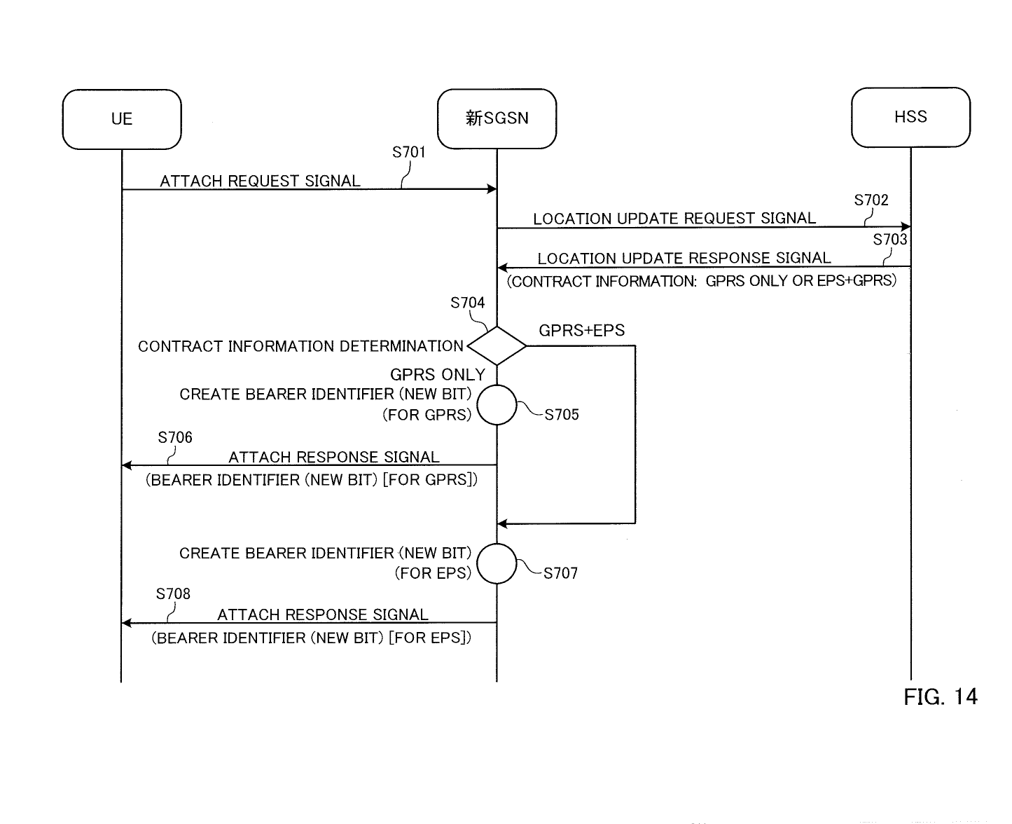

Operation of the mobile communication system upon attach according to the third embodiment will be described mainly on differences from the first embodiment with reference to FIG. 14. FIG. 14 is a sequence diagram showing operation upon attach of the mobile communication system according to the third embodiment. Since steps S701 to S704 in FIG. 14 are similar to steps S101 to S104 in FIG. 5, descriptions thereof will be omitted.

When the contract information is “GPRS only,” the exchange SGSN creates a bearer identifier (new bit) indicating the use of a GPRS bearer (step S705). For example, the exchange SGSN sets the bearer identifier shown in FIG. 13 to “1 (GPRS bearer is used).” The exchange SGSN sends an attach response signal including the set bearer identifier to the mobile terminal UE (step S706).

When the contract information is “EPS+GPRS,” the exchange SGSN creates a bearer identifier (new bit) indicating the use of an EPS bearer (step S707). For example, the exchange SGSN sets the bearer identifier shown in FIGS. 13 to “0 (EPS bearer is used).” The exchange SGSN sends an attach response signal including the set bearer identifier to the mobile terminal UE (step S708).

### Other Embodiments

The present invention has been described in detail using the aforementioned embodiments, but it is obvious to those skilled in the art that the present invention is not limited to the embodiments described in the present DESCRIPTION. The present invention can be implemented as modified or altered embodiments without departing from the spirit and scope of the present invention defined in the description of the scope of patent claims. Therefore, the description of the present DESCRIPTION is intended to be illustrative and by no means intended to limit the scope of the present invention.

The present application is based on Japanese Patent Application No. 2009-293017 filed on Dec. 24, 2009, entire content of which is expressly incorporated by reference herein.

1. A mobile communication method comprising the steps of:
assigning, to a mobile terminal located in a management area of a first exchange, a temporary subscriber identifier indicating a communication path type of a logical communication path established for the mobile terminal, at the first exchange;
receiving, from the mobile terminal having moved from the management area of the first exchange to a management area of a second exchange, a location update request signal including the temporary subscriber identifier, at the second exchange;
sending, from the second exchange having received the location update request signal to the first exchange, a communication path information request signal for requesting to get communication path information stored in the first exchange, by using a protocol corresponding to the communication path type indicated by the temporary subscriber identifier; and
sending, from the first exchange having received the communication path information request signal to the second exchange, a communication path information response signal including the communication path information, by using the same protocol as that of the communication path information request signal.

2. The mobile communication method according to claim 1, wherein in the step of sending the communication path information request signal, the second exchange uses GTPv1 (GPRS Tunneling Protocol, version 1) when the communication path type indicated by the temporary subscriber identifier is a GPRS bearer, and uses GTPv2 (GPRS Tunneling Protocol, version 2) when the communication path type is an EPS bearer.

3. The mobile communication method according to claim 1, wherein in the step of assigning the temporary subscriber identifier, the first exchange assigns a temporary subscriber identifier indicating a communication path type corresponding to contract information of the mobile terminal.

4. The mobile communication method according to claim 3, wherein when the communication path type corresponding to the contract information of the mobile terminal is the EPS bearer but the terminal capability of the mobile terminal does not support the EPS bearer, the first exchange assigns a temporary subscriber identifier indicating a communication path type corresponding to the supported capability of the mobile terminal.

5. The mobile communication method according to claim 1, further comprising the step of, when the communication path type indicated by the temporary subscriber identifier is different from a communication path type of an established communication path for the mobile terminal, reassigning a temporary subscriber identifier indicating the communication path type of the established communication path to the mobile terminal, at the first exchange.

6. The mobile communication method according to claim 1, further comprising the step of, when a communication path type corresponding to a changed terminal capability is different from the communication path type indicated by the temporary subscriber identifier, reassigning a temporary subscriber identifier indicating the communication path type corresponding to the changed terminal capability, at the first exchange.

7. The mobile communication method according to claim 1, further comprising the step of, when a communication path type corresponding to a changed terminal capability matches a communication path type corresponding to contract information, reassigning a temporary subscriber identifier indicating the communication path type corresponding to the changed terminal capability, at the first exchange.

8. The mobile communication method according to claim 1, further comprising the step of, when a communication path type corresponding to a changed contract information is different from the communication path type indicated by the temporary subscriber identifier, reassigning a temporary subscriber identifier indicating the communication path type corresponding to the changed contract information, at the first exchange.

9. The mobile communication method according to claim 1, further comprising the step of, when a communication path type corresponding to a changed contract information matches the communication path type corresponding to the terminal capability, reassigning a temporary subscriber identifier indicating the communication path type corresponding to the changed contract information, at the first exchange.

10. A mobile communication method comprising the steps of:
sending, in response to an attach request signal from a mobile terminal located in a management area of a first exchange, an attach response signal including a communication path type identifier indicating a communication path type of a logical communication path established for the mobile terminal, at the first exchange;
receiving, from a mobile terminal having moved from the management area of the first exchange to a management area of a second exchange, a location update request signal including the communication path type identifier, at the second exchange;
sending, from the second exchange having received the location update request signal to the first exchange, a communication path information request signal for requesting to get the communication path information stored in the first exchange to the first exchange, by using a protocol corresponding to the communication path type indicated by the communication path type identifier; and
sending, from the first exchange having received the communication path information request signal to the second exchange, a communication path information response signal including the communication path information, by using the same protocol as that of the communication path information request signal.

11. The mobile communication method according to claim 10, wherein in the step of sending the communication path information request signal, the second exchange uses GTPv1 (GPRS Tunneling Protocol, version 1) when the communication path type indicated by the temporary subscriber identifier is a GPRS bearer, and uses GTPv2 (GPRS Tunneling Protocol, version 2) when the communication path type is an EPS bearer.

12. An exchange to get, when a mobile terminal moves from a management area of another exchange to a management area of the exchange, communication path information related to the mobile terminal from the other exchange, the exchange comprising:
a location update request signal receiving section configured to receive a location update request signal including a temporary subscriber identifier indicating a communication path type of a logical communication path established for the mobile terminal from the mobile terminal; and
a communication path information getting section configured to send a communication path information request signal for requesting to get communication path information stored in the first exchange to the first exchange by using a protocol supporting a communication path type indicated by the temporary subscriber identifier, and receive a communication path information response signal including the communication path information from the first exchange.

13. An exchange to get, when a mobile terminal moves from a management area of another exchange to a management area of the exchange, communication path information related to the mobile terminal from the other exchange, the exchange comprising:
a location update request signal receiving section configured to receive a location update request signal including a temporary subscriber identifier indicating a communication path type of a logical communication path established for the mobile terminal from the mobile terminal; and
a communication path information getting section configured to send a communication path information request signal for requesting to get communication path information stored in the first exchange to the first exchange by using a protocol supporting a communication path type indicated by the temporary subscriber identifier, and receive a communication path information response signal including the communication path information from the first exchange.
